(19) United States
(12) Patent Application Publication
(10) Pub. No.: US 2018/0290731 A1
(43) Pub. Date: Oct. 11, 2018

(54) MOBILE BODY, COMMUNICATION TERMINAL, AND CONTROL METHOD FOR MOBILE BODY

(71) Applicant: SHARP KABUSHIKI KAISHA, Sakai City, Osaka (JP)

(72) Inventor: IWAO ISHIBASHI, Sakai City (JP)

(21) Appl. No.: 15/765,829

(22) PCT Filed: Dec. 20, 2016
(86) PCT No.: PCT/JP2016/087980

§ 371 Date: Apr. 4, 2018

(30) Foreign Application Priority Data
Dec. 25, 2015 (JP) 2015-253202

(51) Int. Cl. B64C 13/20; B64C 39/02; G05D 1/04; H04M 11/00; H04Q 9/00

(52) U.S. Cl. CPC B64C 13/20; B64C 39/024; G05D 1/04; B64C 2201/146; H04Q 9/00; B64C 2201/027; H04M 11/007

(57) ABSTRACT

The present invention provides a mobile body which can reliably perform a motion intended by a user, irrespective of being within or outside an area of communication with a control device. A drone (3) includes: a first communication section (33) which wirelessly connects to a smartphone (1) after the drone (3) has performed autonomous flight to the vicinity of a destination which has been set; a control section (35) which obtains a position of the smartphone (1); and a movement control section (32) which controls the autonomous flight so that the drone (3) moves closer to the position.

### TECHNICAL FIELD

The present invention relates to a mobile body which autonomously moves to a destination which has been set, and the like.

### BACKGROUND ART

Mobile bodies that can be radio-controlled (e.g., an unmanned aircraft) have been widely used in great varieties. Such mobile bodies range from a mobile body that can be controlled by a user to fly within sight of the user, to a mobile body, such as a military aircraft, that is controlled with use of an artificial satellite. These unmanned aircrafts come in various sizes depending on the use of the unmanned aircrafts. For example, there are an unmanned aircraft for recreational use to enjoy flying the unmanned aircraft, an unmanned aircraft for use in measurement, cropdusting, or the like, and an unmanned aircraft that is capable of transporting goods loaded on the unmanned aircraft. As with manned aircrafts, unmanned aircrafts employing various flight methods exist, such as a fixed-wing aircraft and a rotary-wing aircraft, depending on the use of the unmanned aircrafts.

Recently, there has been developed a multicopter-type unmanned aircraft, which can take a stable posture in the air and therefore is easy to control. Also recently, so-called “drones,” which autonomously fly according to a preset program instead of being always controlled by a human, have been widely used. In particular, the growth of a cellular communication network (a cellular network) has enabled drones to connect to a server via the cellular network, and has accordingly enabled the drones to be controlled from the server even during flight or even on land in a remote location. This has resulted in the development of a service described in Patent Literature 1 and a technology described in Non-patent Literature 1.

### CITATION LIST

### Patent Literature

[Patent Literature 1]

US Patent Application Publication No. 2015/0120094 (Publication Date: Apr. 30, 2015)

### Non-Patent Literature

[Non-Patent Literature 1]

http://www.theguardian.com/technology/2015/jun/03/verizon-nasa-drones-cellphone-towers (viewed on Sep. 24, 2015)

### SUMMARY OF INVENTION

### Technical Problem

The technology described in Patent Literature 1 is based on the assumption that goods ordered by a customer are loaded on a drone owned by a mail-order company, and are delivered to the customer. As such, despite being capable of autonomous flight, the drone communicates with a server, which is provided by the mail-order company, via a network (e.g., connection to the Internet via a cellular network), and sets, in accordance with an instruction from the server, a place (a destination) to which the drone is to go. The technology described in Non-patent Literature 1 is an attempt to use a base station of a cellular network in order to provide a drone with a flight control system similar to an air traffic control for a manned aircraft. Thus, neither Patent Literature 1 nor Non-patent Literature 1 assumes a case in which a drone flies to a place (e.g., outside an area of communication with a cellular network) where the drone cannot connect to a network.

In a case where a drone uses either one of these technologies when flying outside an area of communication, the drone cannot be controlled by a server and the like. Accordingly, the drone needs to reach a destination automatically and perform an operation at the destination (e.g., delivery of a commercial product by landing or dropping the commercial product) automatically. This may prevent the drone from accomplishing a purpose intended by the user, due to the weather, surroundings, and the like at the destination.

The present invention is accomplished in view of the foregoing problem. An object of the present invention is to provide a mobile body or the like which can reliably perform a motion intended by a user, irrespective of being within or outside an area of communication with a control device.

### Solution to Problem

In order to attain the object, a mobile body in accordance with one aspect of the present invention is a mobile body performing autonomous movement to the vicinity of a destination which has been set, including: a first communication section wirelessly connecting to a communication terminal which controls the mobile body in accordance with an input operation; a terminal position identification section identifying a position of the communication terminal which has been wirelessly connected to by the first communication section; and a movement control section controlling the autonomous movement so that the mobile body moves closer to the position identified by the terminal position identification section.

### Advantageous Effects of Invention

According to one aspect of the present invention, a mobile body can reliably perform a motion intended by a user even outside an area of communication with a control device.

### BRIEF DESCRIPTION OF DRAWINGS

FIG. 1 is a block diagram illustrating configurations of main parts of a smartphone, a management server, and a drone which are included in a flight control system in accordance with Embodiment 1 of the present invention.

FIG. 2 is a flowchart showing a flow of processes from when the smartphone calls out the drone to when the drone starts a flight in the flight control system.

FIG. 3 is a flowchart showing a flow of processes up to when the drone, which has been called out, lands in the flight control system.

### DESCRIPTION OF EMBODIMENTS

### Embodiment 11

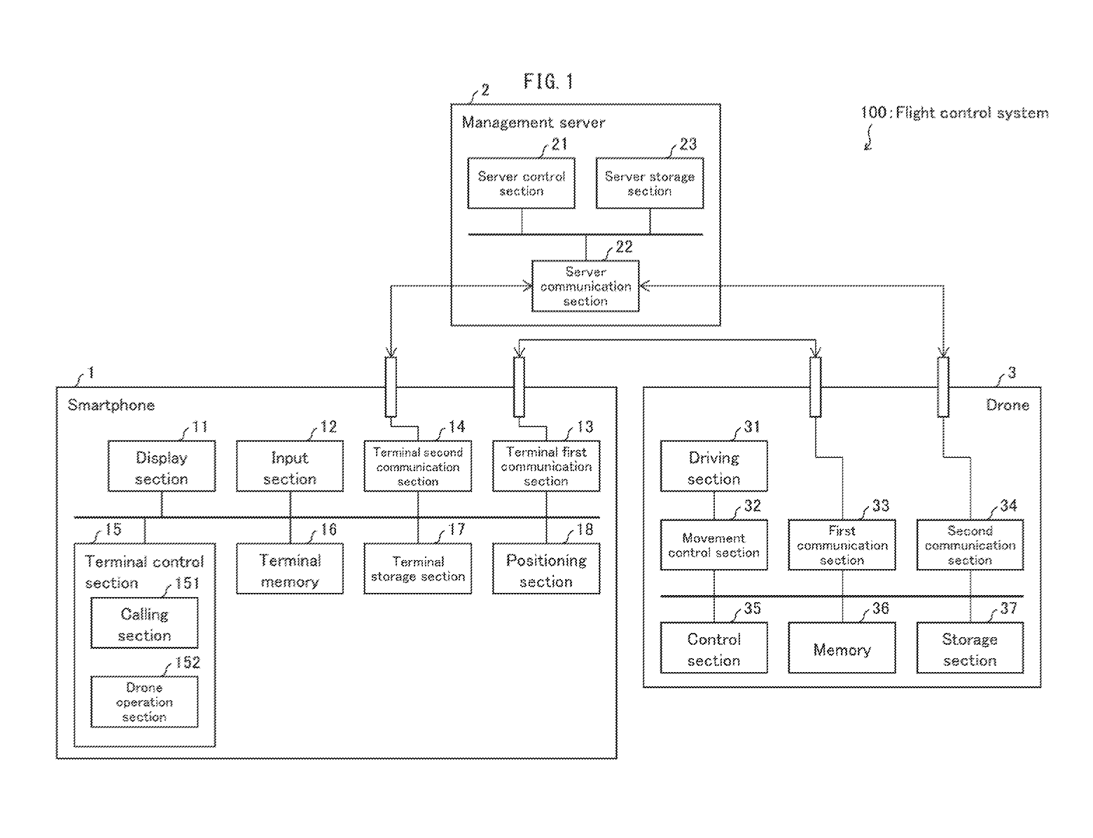

The following description will discuss Embodiment 1 of the present invention with reference to FIGS. 1 through 3. First, the following description will discuss, with reference to FIG. 1, a function of a flight control system 100 in accordance with Embodiment 1 and configurations of main parts of a smartphone 1, a management server 2, and a drone (a mobile body) 3 which are included in the flight control system 100. FIG. 1 is a block diagram illustrating configurations of main parts of the smartphone 1, the management server 2, and the drone 3 which are included in the flight control system 100 in accordance with Embodiment 1.

(Flight Control System)

The flight control system 100 in accordance with Embodiment 1 is a system in which the drone 3, which is provided (disposed) in a standby state in a predetermined place, is called out by the smartphone 1 via the management server 2 to the vicinity of a position (a position at the time of calling) of the smartphone 1, and when the drone 3 has come to the vicinity of the smartphone 1, the smartphone 1 communicates with the drone 3 directly without being mediated by the management server 2, so that the drone 3 can be radio-controlled irrespective of being within or outside an area of communication with a cellular network.

As illustrated in FIG. 1, the management server 2 communicates with the smartphone 1 and the drone 3 in the flight control system 100. Further, the smartphone 1 and the drone 3 also communicate with each other. Note that a method of communication between the management server 2 and each of the smartphone 1 and the drone 3 is not particularly limited. Examples of communication between the management server 2 and each of the smartphone 1 and the drone 3 may encompass communication utilizing a cellular network used by a mobile phone and the like, wired or wireless communication via the Internet, and the like.

Meanwhile, a method of communication between the smartphone 1 and the drone 3 is wireless connection, in which the smartphone 1 and the drone 3 are directly connected to each other without use of a relay station such as a base station or a server. Examples of the method of communication between the smartphone 1 and the drone 3 may encompass Wi-Fi (registered trademark) communication, Bluetooth (registered trademark) communication, and the like. Hereinafter, the above-described connection between the smartphone 1 and the drone 3 will be simply referred to as “direct connection.”

Application fields for the flight control system 100 are not particularly limited, but the flight control system 100 is useful in, for example, a case in which goods required in an emergency situation (e.g., AED) are transported with use of the drone 3. The following description will discuss an example case in which such emergency transportation is carried out with use of the drone 3. Note that, in this case, an owner of the smartphone 1 (i.e., a person who calls out the drone 3) is synonymous with a reporter who reports that there is an emergency situation and transportation of the goods is necessary. A provider of the drone 3 is a public institution such as a fire department, and at least one drone 3 is disposed in a standby state at a fire station, a predetermined warehouse, or the like. In a case where the reporter uses the smartphone 1 to request the management server 2 to call out a drone, the management server 2 selects at least one of drone(s) 3 disposed at the fire station or the warehouse, and causes the at least one of the drone(s) 3 to take off.

(Smartphone 1)

The smartphone 1 is a communication terminal owned by the reporter. As illustrated in FIG. 1, the smartphone 1 includes a display section 11, an input section 12, a terminal first communication section (a wireless connection section) 13, a terminal second communication section 14, a terminal control section 15, a terminal memory 16, and a terminal storage section 17.

The display section 11 is a display which displays an image in accordance with an instruction from the terminal control section 15. The input section 12 receives an input operation given to the smartphone 1 by the reporter, and transmits the input operation to the terminal control section 15. It is preferable that the display section 11 and the input section 12 be provided integrally in a form of a touch panel. The terminal first communication section 13 communicates with a first communication section 33 (described later) of the drone 3, and the terminal second communication section 14 communicates with a server communication section 22 (described later) of the management server 2. Difference between communications carried out by the terminal first communication section 13 and communications carried out by the terminal second communication section 14 will be described later.

The terminal memory 16 is a temporary storage area on which data used for a process carried out by the terminal control section 15 is temporarily loaded. The terminal storage section 17 stores therein information necessary for realizing functions of the smartphone 1. A positioning section 18 measures a current position of the smartphone 1. It is only necessary that the positioning section 18 is capable of identifying the current position of the smartphone 1, and a configuration of the positioning section 18 and a positioning method used by the positioning section 18 are not particularly limited. Specifically, the positioning section 18 may be realized in a form of a receiver of a satellite positioning system such as GPS (global positioning system) or GLONASS. Alternatively, the positioning section 18 may be configured to obtain information of the current position from a base station with which the smartphone 1 communicates. Further, it is also possible to employ a combination of these positioning methods. Note that it is more preferable that the positioning section 18 obtain not only the current position measured but also a map of an area around the current position (an area within approximately several km²) and transmit the map to the terminal control section 15. It is also possible to employ a configuration in which map data is stored in the terminal storage section 17, and the positioning section 18 reads out, from the terminal storage section 17, a map of an area around the current position measured and transmits the map to the terminal control section 15.

The terminal control section 15 performs overall control of the smartphone 1. The terminal control section 15 includes a calling section 151 and a drone operation section (an instruction transmission section) 152.

In accordance with the input operation which the terminal control section 15 has received from the input section 12, the calling section 151 makes a calling request to the management server 2 to call out the drone 3. Further, the calling section 151 reads out, from the terminal storage section 17, information necessary for making a direct connection to the drone 3, and transmits the information to the management server 2. Furthermore, the calling section 151 transmits, to the management server 2, the current position (i.e., a position of the reporter at the time of making the report) of the smartphone 1 measured by the positioning section 18. Note that the “information necessary for making a direct connection” is, for example, information indicating a method of communication (Wi-Fi (registered trademark) communication or Bluetooth (registered trademark) communication) between the smartphone 1 and the drone 3, an ID of the smartphone 1 to be used at the time of making the direct connection, a password for communication, and the like. In other words, it is only necessary that the “information necessary for making a direct connection” include information (terminal-identifying information) which at least allows the drone 3 to identify the smartphone 1 uniquely when the drone 3 has arrived at the vicinity of a destination.

In accordance with the input operation received from the input section 12, the drone operation section 152 creates a control instruction to be transmitted to the drone 3, and transmits the control instruction to the drone 3 via the terminal first communication section 13, so that the drone 3 is controlled by the smartphone 1. The control instruction is not particularly limited, but it is preferable that the drone operation section 152 be at least capable of (i) creating a landing instruction for instructing the drone 3 to land and (ii) transmitting the landing instruction to the drone 3. Since the reporter is not necessarily used to operating the drone 3, it is more preferable that the input operation and the control instruction be each easily operable and comprehensible.

(Management Server 2)

The management server 2 is a management device which receives the calling request to call out the drone 3 and transmits, to the drone 3, information indicative of a destination and information necessary for making a connection to the smartphone 1 after the drone 3 arrives at the destination. The management server 2 includes the server communication section 22, a server control section 21, and a server storage section 23.

The server communication section 22 communicates with the terminal second communication section 14 of the smartphone 1 and a second communication section 34 of the drone 3. The server storage section 23 stores therein information necessary for realizing functions of the management server 2.

The server control section 21 performs overall control of the management server 2. Upon receipt, from the terminal control section 15 of the smartphone 1, of the calling request to call out the drone 3, the server control section 21 makes a request to the terminal control section 15 for information necessary for making a direct connection between the smartphone 1 and the drone 3 and a current position of the smartphone 1, and obtains the information and the current position. Further, the server control section 21 transmits the information necessary for making a direct connection and the current position of the smartphone 1, which have been obtained, to the drone 3. At this time, the management server 2 may also transmit, to the drone 3, an instruction to set the current position of the smartphone 1 as a destination as well as an instruction to start a flight.

(Drone 3)

The drone 3 is a radio-controlled aircraft (e.g., a multicopter-type unmanned aircraft) which autonomously moves (e.g., autonomously flies) toward a destination which has been set. In Embodiment 1, the drone 3 has a function of flying under control of the management server 2, a function of flying under control of the smartphone 1, and a function of autonomously flying on its own. In order to perform, for example, transportation of goods, it is preferable that the drone 3 have a space for storing the goods inside a main body of the drone 3 or have a mechanism which allows the goods to be immobilized.

More specifically, the drone 3 includes the first communication section 33, the second communication section 34, a driving section 31, a movement control section 32, a memory 36, a storage section 37, and a control section (a terminal position identification section) 35.

The first communication section 33 communicates with the smartphone 1 by directly connecting to the smartphone 1. The second communication section 34 also communicates with the management server 2. The driving section 31 is provided for causing a mechanism for flight (e.g., a propeller) to operate. Specifically, the driving section 31 means a source of power such as a motor, or a mechanism which causes a change in inclination or orientation of a propeller or the like. The movement control section 32 controls the driving section 31 under control of the control section 35. The memory 36 is a temporary storage area on which data used for a process carried out by the control section 35 is loaded. The storage section 37 stores therein information necessary for realizing functions of the drone 3.

The control section 35 performs overall control of the drone 3. The control section 35 sets a place that is a destination of autonomous flight carried out by the drone 3. In Embodiment 1, the control section 35 sets, as the destination of the autonomous flight carried out by the drone 3, the current position of the smartphone 1 received from the management server 2.

In a case where the control section 35 determines that the drone 3 has arrived at the vicinity of the destination, the control section 35 monitors whether or not an antenna of the first communication section 33 has received radio waves transmitted from the smartphone 1. In a case where the antenna has received the radio waves, the control section 35 gives an instruction to make a direct connection to the smartphone 1 via the first communication section 33. Further, in a case where the direct connection is established, the control section 35 identifies a position of the smartphone 1, and instructs the movement control section 32 to control the flight so as to move closer to the position thus identified. Further, upon receipt, from the smartphone 1, an instruction (a flight instruction or a landing instruction) for the drone 3, the control section 35 instructs the movement control section 32 to carry out control in accordance with the instruction.

<<Flow of Processes from Call-Out of Drone to Start of Flight>>

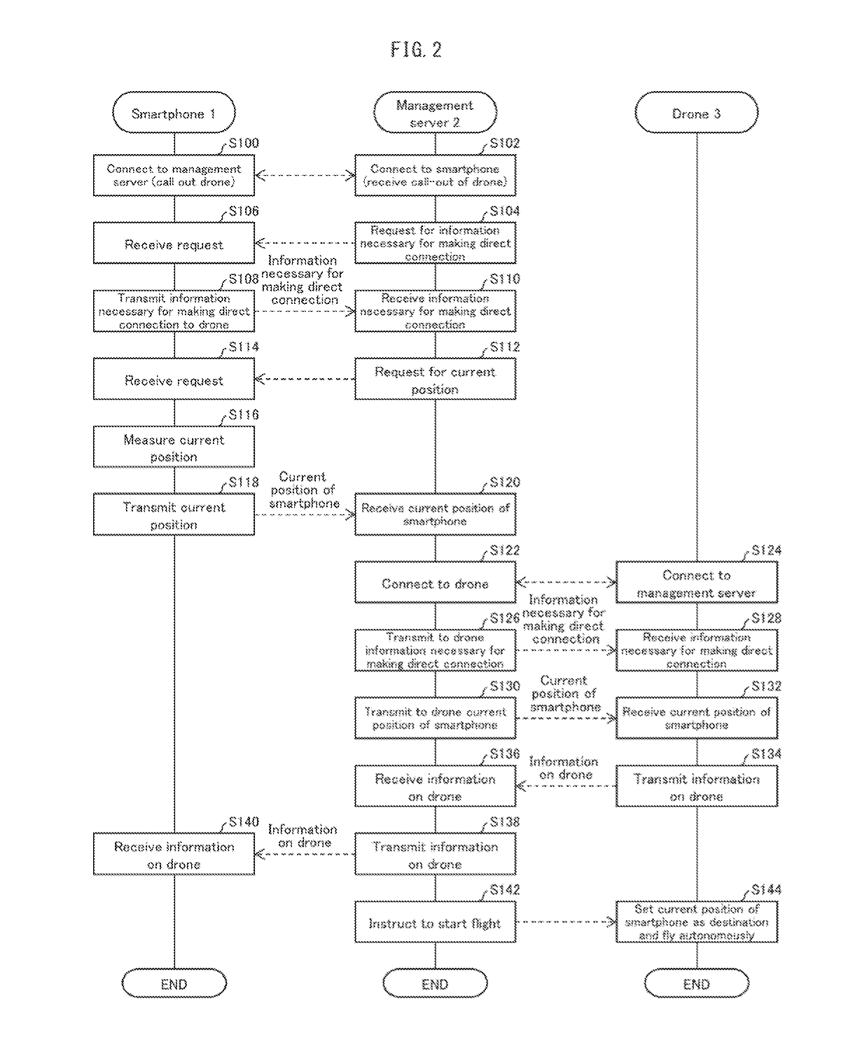

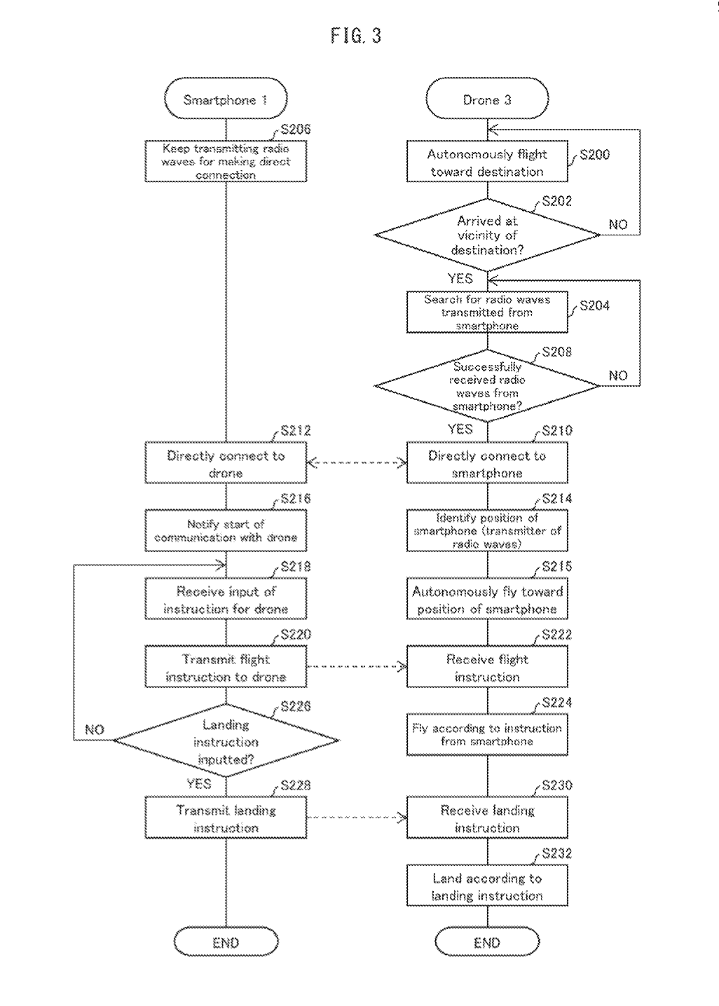

Next, the following description will discuss, with reference to FIGS. 2 and 3, a flow of processes carried out in the flight control system 100 in accordance with Embodiment 1, from a call-out of the drone 3 to landing (completion of delivery of goods) on a position desired by the person (the reporter) who calls out the drone 3. FIG. 2 is a flowchart showing a flow of processes from when the smartphone 1 calls out the drone 3 to when the drone 3 starts a flight.

Upon receipt of an input from the reporter through the input section 12, the smartphone 1 connects to the management server 2 in accordance with the input operation, and makes a request to the management server 2 to call out the drone 3 (S100). The server control section 21 of the management server 2 receives the request to call out the drone 3 (S102), and makes a request, via the server communication section 22, to the terminal control section 15 of the smartphone 1 for information necessary for making a direct connection between the smartphone 1 and the drone 3 (S104). Upon receipt of the request (S106), the terminal control section 15 of the smartphone 1 obtains, from the terminal storage section 17 or the like, the information necessary for making a direct connection between the smartphone 1 and the drone 3, and transmits the information to the management server 2 (S108). Upon receipt of the information (S110), the management server 2 makes a request to the smartphone 1 to transmit a current position (S112). Upon receipt of the request (S114), the smartphone 1 causes the positioning section 18 to measure a current position of the smartphone 1 (S116), and transmits information indicative of the current position measured to the management server 2 (S118). The management server 2 receives the information (information indicative of a destination) indicative of the current position of the smartphone 1 (S120).

When the server control section 21 of the management server 2 has thus obtains, from the smartphone 1, the information necessary for making a direct connection and the current position of the smartphone 1, the server control section 21 selects, from among drones 3 on which emergency goods are loaded, a drone 3 suitable for heading to the reporter (in a case where there is only one drone 3, the server control section 21 selects that one drone 3) on the basis of, for example, a predetermined standard or a selection made by the provider of the drones 3. In making the selection, it is preferable that the drone 3 be selected in consideration of (i) whether or not the drone 3 is capable of making a direct communication with the smartphone 1 (whether or not the drone 3 has a function of communicating in accordance with a communication method suitable for the direct communication), (ii) a charging status of the drone 3, and (iii) a place in which the drone 3 is provided (in a case where drones 3 are provided in multiple places, a drone 3 that is located as close to the current position of the smartphone 1 as possible is desirable among the drones 3). Especially in a case where a plurality of drones 3 whose driving sections are implemented in respective different manners are provided, it is preferable that selection of a drone 3 be made in consideration of differences between the driving sections implemented. For example, in a case where the reporter is at or near a place that is designated as a no-fly zone, it is preferable that a drone 3 having a driving section for running on land or water in addition to a driving section for flying.

Then, the server control section 21 connects, via the server communication section 22, to the drone 3 which has been selected (S122 and S124), and transmits, to the drone 3, the information necessary for making a direct connection and the current position of the smartphone 1 (S126 and S130). Upon reception of these pieces of information via the second communication section 34 (S128 and S132), the control section 35 of the drone 3 reads out information on the drone 3 from the terminal storage section 17 or the like, and transmits the information to the management server 2 (S134). Note that the processes of S134 through S140 are not essential, but are preferably carried out. For example, in a case where it is necessary to use specific application software in order for the smartphone 1 to connect to the drone 3, the “information on the drone 3” may be information indicative of the application software. Further, in order for the reporter to identify the drone 3 with eyes, a photograph or the like showing an appearance of the drone 3 may be transmitted as the information on the drone 3. It is also possible to employ a configuration in which, in a case where a current position of the smartphone 1 is set as a destination, information indicative of a route along which the drone 3 will be flying is transmitted to the smartphone 1, so that the route can be displayed on a map which is stored in the terminal storage section 17 or the like of the smartphone 1. Further, it is also possible to transmit, as the information on the drone 3, an expected arrival time (what time or in how many hours the drone 3 will arrive) of the drone 3 at the current position of the smartphone 1. In other words, it is only necessary that the “information on the drone 3” transmitted by the drone 3 at S134 be information which is used at a later step by the reporter in order to find the drone 3 more easily.

Upon receipt of the information on the drone 3 from the drone 3 (S136), the server control section 21 of the management server 2 transmits the information on the drone 3 to the smartphone 1 (S138). The terminal control section 15 of the smartphone 1 receives the information on the drone 3 (S140). Note that the server control section 21 of the management server 2 may notify the smartphone 1 of the estimated arrival time of the drone 3 and a completion of receipt of the report, together with the information on the drone 3. Further, the server control section 21 of the management server 2 may instruct the drone 3 to start a flight (S142). Upon receipt of such a flight instruction or upon completion of receipt of the information necessary for making a direct connection and the current position of the smartphone 1 (S128 and S132), the control section 35 of drone 3 sets the current position of the smartphone 1 received (i.e., the position of the smartphone 1 and the reporter at the time of the report) as a destination, and causes the movement control section 32 to control the drone 3 to fly autonomously to the destination set (S144).

Note that when making a request to the management server 2 to call out the drone 3 (S100), the smartphone 1 may measure a current position of the smartphone 1 with use of the positioning section 18 and transmit the current position to the management server 2 together with the request to call out the drone 3. In this case, the processes of S112 through S120 can be omitted. Further, when making the request to call out the drone 3, the smartphone 1 may transmit, to the management server 2, the information necessary for making a direct connection, together with the request to call out the drone 3. In this case, the processes indicated as S104 through S110 can be omitted. Further, the processes indicated as S104 through S110 and related to transmission and reception of the information necessary for making a direct connection may be carried out after or simultaneously with the processes indicated as S112 through S120 and related to transmission and reception of the current position of the smartphone 1. That is, management server 2 may collectively transmit, to the smartphone 1, both a request for the information necessary for making a direct connection and a request for the current position of the smartphone 1, and the smartphone 1, upon receipt of the requests, may transmit both of the information necessary for making a direct connection and the current position of the smartphone 1 to the management server 2.

When calling out the drone 3 (S122), the management server 2 may transmit, to the drone 3, the information for making a direct connection and the current position of the smartphone 1 together. In this case, the processes of S126 through S132 can be omitted. Further, when the management server 2 notifies the smartphone 1 of a completion of receipt of the report at S140 (or after S140), the notification from the management server 2 may include information indicative of things to be preferably done or understood by the owner of the smartphone 1 (i.e., the reporter) before arrival of the drone 3. Examples of the information include a wish that the owner keep the smartphone 1 turned on until the estimated arrival time, a wish that the owner start up, before the arrival time, software for operating the drone 3, a wish that the owner bring the smartphone 1, before the arrival time, to the vicinity of a desirable place to be landed on by the drone 3 and wait at the desirable place, and a guide on how to operate the drone 3. Note that these examples of the information may be stored in the smartphone 1 instead of being transmitted from the management server 2. For example, it is possible to employ a configuration in which in a case where the smartphone 1 receives a completion of receipt of the report, these guides stored in the terminal storage section 17 or the like of the smartphone 1 are read out by the terminal control section 15 and are displayed on the display section 11 (or outputted as voice guidance via a speaker or the like (not illustrated)).

<<Flow of Processes from Arrival of Drone 3 at Vicinity of Destination>>

When the call-out of the drone 3 has been completed (S140) and the drone 3 has started autonomous flight to the destination (S144) as described with reference to FIG. 2, the reporter waits until arrival of the drone 3. FIG. 3 is a flowchart showing a flow of processes up to when the drone 3, which has been called out, lands at a location of the reporter in the flight control system 100. Since the above waiting, in order to allow the drone 3 to make a direct connection to the smartphone 1 any time, the terminal first communication section 13 of the smartphone 1 keeps transmitting, via the antenna of the terminal first communication section 13 and in accordance with a communication method which has been predetermined, radio waves for making a direct connection with the drone 3 (S206). Note that in a case where the estimated arrival time of the drone 3 is known, transmission of the radio waves may be started only when the estimated arrival time has approached (e.g., 2 to 3 minutes before the estimated time), in order to save electricity. Note that it is preferable that while the smartphone 1 is able to connect to the management server 2 (while the smartphone 1 is within an area of radio waves of a cellular network to which the smartphone can connect), the smartphone 1 periodically (e.g., every 30 seconds) measure a current position of the smartphone 1 with use of the positioning section 18 and, in a case where the position of the smartphone 1 has moved by a certain distance (approximately several ten meters) or more from a position that was last transmitted to the management server 2, the smartphone 1 notify the management server 2 of a current position of the smartphone 1 (i.e., the smartphone 1 notifies the management server 2 of a position of the smartphone 1 at an interval of every several ten meters). Further, it is preferable that the reporter himself/herself be caused to input, on a map displayed on the smartphone 1, a location to which the reporter will bring the smartphone 1, so that information indicative of the position inputted can be notified to the drone 3 via the management server 2. This is useful, for example, in a case where the reporter knows a place nearby that is suitable for the drone to land on, such as an open square, a rooftop of a building, or the like.

Meanwhile, the drone 3 on which the goods are loaded performs autonomous flight toward the destination which has been set, that is, toward the current position of the smartphone 1 at the time of the reporting (S200). Note that a route of flight of the drone 3 and how the route is decided is not particularly limited, but it is preferable to decide on a route that allows the drone 3 to fly while both avoiding other drones, buildings, obstacles, and the like and maintaining an appropriate altitude from the ground. The autonomous flight is continued until the control section 35 detects that the drone 3 has arrived at the vicinity of the destination which has been set (detects that the drone 3 has entered a predetermined range from the destination) (NO at S202).

In a case where the control section 35 of the drone 3 detects that the drone 3 has arrived at the vicinity of the destination (YES at S202), the control section 35 searches for the radio waves transmitted from the smartphone 1 by monitoring whether or not the antenna of the first communication section 33 has received the radio waves (S204). More specifically, the control section 35 of the drone 3 searches for the radio waves that are transmitted via the antenna of the terminal first communication section 13 in the vicinity of the destination in accordance with the communication method which has been preset (a method indicated by the information which is indicative of a communication method and is included in the information necessary for making a direct connection).

Note that “the vicinity of the destination” means a position at which the drone 3 has come “sufficiently” close to the smartphone 1. Specifically, “the vicinity of the destination” means an area which centers around the destination and is calculated on the basis of a distance within which the smartphone 1 and the drone 3 can communicate with each other in accordance with a communication method used in a direct connection which will be described later (S210 and S212). For example, in a case of employing a communication method in which the distance within which the smartphone 1 and the drone 3 can communicate with each other via a direct connection is approximately 100 m, the drone 3 should start the search for radio waves shown in S204 when the drone 3 has flown to a point which is within at least 100 m from the destination (more preferably, within 200 m to 300 m from the destination). Further, it is preferable that the drone 3 fly as fast as possible (at a maximum speed of the drone 3) until performing the search for radio waves shown in S204, and slow down to a flight speed that does not cause a hindrance to making a connection in accordance with the communication method, after detection of radio waves is started.

The control section 35 of the drone 3 continues the detection of radio waves until the antenna of the first communication section 33 can receive the radio waves that are transmitted from the smartphone 1 at S206 (NO at S208). Then, in a case where the antenna of the first communication section 33 has successfully received the radio waves (YES at S208), the control section 35 controls the first communication section 33 to establish a direct connection to the smartphone 1 (S210, a first communication step). Specifically, upon detection of the radio waves from the smartphone 1, the control section 35 of the drone 3 attempts to connect to a transmitter of the radio waves with use of the ID and the like (terminal-identifying information), which have been received in advance, of the smartphone 1. This is a method similar to a method used in a case where, for example, a general smartphone connects to the Internet via Wi-Fi.

When the direct connection has been established, the control section 35 of the drone 3 identifies a position of the smartphone 1 (the transmitter of the radio waves) (S214, a terminal position identification step), and causes the movement control section 32 to control the drone 3 to perform autonomous flight toward (a position up in the air above) the position identified (S215, a movement control step). In other words, the control section 35 of the drone 3 sets the identified position of the smartphone 1 as a new destination of the drone 3 (updates the destination), and performs autonomous flight toward the destination. Note that how the control section 35 identifies the position of the smartphone 1 is not particularly limited. For example, the control section 35 may communicate with the smartphone 1 and receive information of a position measured by the positioning section 18 of the smartphone 1. Further, the drone 3 may be configured such that, while causing the drone 3 to move and rotate, the control section 35 receives radio waves via the antenna of the first communication section 33 (in order to seek for a direction in which radio waves have a high intensity, an antenna with high directivity is preferable), identifies a direction of the smartphone 1 and a distance of the smartphone 1 from the drone 3 on the basis of the principle of triangulation with use of an intensity of the radio waves received, and uses the direction and the distance as a position of the smartphone 1. Usually, the drone 3 has a size of approximately 2 m² to 3 m². As such, in order to allow the reporter to operate the drone under visual observation so as to cause the drone to land as described later, it is necessary to cause the drone 3 to move closer to the reporter so as to enter a range (at a distance of approximately several ten meters) within which the reporter can sufficiently recognize the drone 3 with eyes. Accordingly, when the direct connection has been established, the drone 3 identifies a position of the smartphone 1, and flies toward the position as described above. In this manner, while checking the direction from which the radio waves from the smartphone 1 are transmitted, the drone 3 moves closer to the smartphone 1 so as to enter a range within which the reporter can sufficiently recognize the drone 3 with eyes. This allows the reporter to recognize, easily with eyes, the drone 3 which has been called out by the reporter.

Meanwhile, when the direct connection between the smartphone 1 and the drone 3 has been established (S212), the terminal control section 15 of the smartphone 1 notifies the reporter, via the display section 11 (or an output section such as a speaker), that the smartphone 1 has started communicating with the drone 3 (S216), and urges the reporter to find the drone 3. The smartphone 1 receives an instruction input from the reporter via the input section 12 (S218). Note here that the instruction input received by the input section 12 is an input for determining an instruction for the drone 3. The instruction input received by the input section 12 is transmitted to the drone operation section 152 of the terminal control section 15, and the drone operation section 152 transmits a flight instruction (a control instruction regarding flight of the drone 3) to the drone 3 in accordance with the instruction input (S220). Upon receipt of the flight instruction via the first communication section 33 (S222), the control section 35 of the drone 3 instructs the movement control section 32 to fly in accordance with the flight instruction indicated by the smartphone 1, and the movement control section 32 controls the driving section 31 in accordance with the instruction (S224). The instruction input by the reporter and the transmission of the flight instruction to the drone 3 are repeated until the reporter gives the input section 12 an input operation indicative of a landing instruction (NO at S226). Meanwhile, in a case where the reporter has given an instruction indicative of a landing instruction (an instruction to cause the drone 3 to land) (YES at S226), the drone operation section 152 transmits the landing instruction to the drone 3 (S228). Upon receipt of the landing instruction (S230), the control section 35 of the drone 3 instructs the movement control section 32 to cause the drone 3 to land in accordance with the landing instruction, and the movement control section 32 causes the drone 3 to land in accordance with the instruction (S232).

At S200, it is preferable that the control section 35 of the drone 3 communicate with the management server 2 periodically while the control section 35 is able to connect to the management server 2 via the second communication section 34 (while the control section 35 is within an area of radio waves of the cellular network). It is also preferable that, in a case where a new current position of the smartphone 1 has been transmitted to the management server 2, the control section 35 receive information indicative of the new current position from the management server 2, update the destination of the drone 3 to the new current position, and instruct the movement control section 32 to fly toward the destination updated. This allows minimizing an occurrence of a situation in which the drone 3 cannot connect to the smartphone 1 even after arriving at the vicinity of a destination. Further, it is also possible to employ a configuration in which, while the control section 35 of the drone 3 is able to connect to the management server 2, the control section 35 transmits, to the management server 2 as appropriate, information indicative of a current position, a route of flight, an estimated arrival time, and the like. This allows the smartphone 1 to connect to the management server 2 so as to refer to information indicative of a current situation of the drone 3. Accordingly, the reporter can find the drone 3 more quickly and easily.

Further, a function that allows the reporter to transmit an instruction to the drone 3 via the smartphone 1 (control the drone 3, S218 through S232) may be realized with use of predetermined application software installed in the smartphone 1. In addition, processes related to call-out of the drone 3 (processes carried out by the smartphone 1 at S100 through S118 in FIG. 2, and S140) and processes of notifying whether or not the smartphone 1 and the drone 3 are successfully connected to each other (S212, S216) may also be realized with use of predetermined application software.

The reporter who is carrying the smartphone 1 may not necessarily be at a position at which the reporter made a report. For example, in a case where a person who needs goods (e.g., a person to be rescued) is in a place that is outside an area of a cellular network (not necessarily a cellular network provided by the same provider as that of a cellular network to which the drone 3 connects) to which the smartphone 1 connects, the reporter may have made a report after moving to a place where the smartphone 1 could be connected to the cellular network to which the smartphone 1 connects. It may be also possible that after making a report (after S140 in FIG. 2), the reporter has moved in search of a place that is easier for the drone to land on (note here that the reporter can be assumed to be in a range of only several tens to several hundreds of meters from a position at which the reporter first made the report). As such, in a case where the drone 3 cannot connect to the smartphone 1 even after arriving at the vicinity of a position up in the air above a current position, at the time of the report, of the smartphone 1 (NO at S208), the drone 3 may search for the smartphone 1 by any of the following methods.

As a first method, the drone 3 may fly within a certain area around a current position (at the time of the report) of the smartphone 1 so as to search for a place at which the drone 3 can make a direct connection to the smartphone 1. Then, in a case where the drone 3 has successfully made the direct connection to the smartphone 1 even for a short period of time in any place within the above area, the control section 35 may instruct the movement control section 32 to decrease a flight speed near the place, and the movement control section 32 may control the driving section 31 to slow down the drone 3 while the movement control section 32 seeks for a direction in which an intensity of radio waves from the smartphone 1 received by the first communication section 33 increases.

As a second method, the drone 3 may move to a place at which the drone 3 can connect to a cellular network for the drone 3, and may call out the smartphone 1 via the cellular network. In this case, in order for the drone 3 to identify the place at which the drone 3 can connect to the cellular network, the drone 3 preferably keeps a history of a route along which the drone 3 has moved and a place at which the drone 3 connected to the cellular network. Further, in a case where the smartphone 1 is in a place at which the smartphone 1 can connect to the cellular network (for the smartphone 1), the drone 3 causes the smartphone 1 to transmit a current position of the smartphone 1 again to the drone 3 via the cellular network, and the drone 3 moves to the place. Note that the above-described exchange of information of a new position between the smartphone 1 and the drone 3 via the cellular network may be carried out via the management server 2. That is, it is possible to employ a configuration in which, during a time in which the smartphone 1 waits for the drone 3 to arrive, the smartphone 1 keeps transmitting information of a new position to the management server 2 at an appropriate interval while being connect to the cellular network, and the drone 3 obtains the latest position of the smartphone 1 from the management server 2 when the drone 3 is connected to the cellular network. This allows reducing an error between a destination of the drone 3 and a position of the smartphone 1 at the time of arrival of the drone 3 to the vicinity of the destination. Note that in a case where the smartphone 1 has notified the management server 2 of the latest current position as described above, the drone 3 may reset the destination to the latest current position and head to the destination which has been reset.

In a case where the smartphone 1 still cannot be found, the drone 3 may search a previous location of the smartphone 1. Note that the previous location of the smartphone 1 is not a current position (the latest current position) that was last transmitted by the smartphone 1, and can be identified on the basis of a current position (a current position transmitted in the past) that had been transmitted before the latest current position was transmitted.

Alternatively, upon receipt of a current position of the smartphone 1, the drone 3 preferably stores the current position such that the current position is associated with a map which the drone 3 has (so that a reference is made as to where in the map the smartphone 1 is located). Accordingly, in a case where a current position of the smartphone 1 is along a road on the map, the drone 3 can conduct a search, along the road, for a place to which the smartphone 1 (i.e., the reporter) is likely to move.

Further, in a case where a location to which the reporter will move has been inputted by the reporter to the smartphone 1 so as to notify the drone 3 of the location, the drone 3 may head to near the location which has been inputted. In particular, in a case where a rooftop of a building has been inputted, it may be possible that the drone 3 cannot find the smartphone 1 because, for example, the reporter is on an elevator inside the building. In such a case, it may be possible that the drone 3 can find the smartphone 1 when the reporter arrives at the rooftop.

As a third method, in a case where a plurality of communication methods are provided for the drone 3 to use in order to make a direct connection to the smartphone 1, other communication methods may be used in an attempt to make the connection. In this case, when attempting to make a connection by one communication method, the drone 3 can attempt to make a communication by other communication method(s) concurrently. Alternatively, the drone may determine, in accordance with degrees of priority of the plurality of communication methods, which one of the plurality of communication methods should be used to make a communication, and may attempt to make a connection by sequentially using the respective plurality of communication methods. For example, the drone 3 may prioritize a communication method with a longer communication distance, or a communication method with which it is easier to maintain a connection more stably.

As a fourth method, in a case where the reporter has found the drone 3, the reporter may be caused to increase an intensity of the radio waves transmitted from the smartphone 1. In this case, the terminal control section 15 causes the display section 11 or the like to urge the reporter to (i) move closer to the drone 3 or (ii) move to a place where the reporter can see a long way. Further, in order to allow the drone 3 to be found easily, the drone 3 may output a siren or, in nighttime, turn on a light.

As a fifth method, in a case where the smartphone 1 cannot connect to the drone 3 (i) even when a predetermined period time has elapsed after the estimated arrival time of the drone 3 or (ii) even when the estimated arrival time will come in less than a certain length of time (e.g., the estimated arrival time will come in 10 seconds), the terminal control section 15 of the smartphone 1 may display a position, last transmitted to the management server 2, of the smartphone 1 on the map and urge the reporter to move closer to the location. Alternatively, the smartphone 1 may transmit the radio waves at an increased intensity.

Note that the following implementation is also possible. That is, the drone 3 may include a camera for filming a view in front of the drone 3, and after the drone 3 has connected to the smartphone 1, a filmed video may be transmitted to the smartphone 1 of the reporter on a real-time basis so as to be displayed on the smartphone 1. This allows the reporter to operate the drone 3 from a viewpoint of the drone 3 and accordingly operate the drone 3 more easily as compared with a case in which the reporter operates the drone 3 from a viewpoint of the reporter. In this case, too, the drone 3 preferably performs autonomous flight so as to enter a range within which the drone 3 is visible to the reporter. This is because the reporter cannot easily tell which location is being filmed by the camera of the drone in a case where the drone is far away.

Further, even after the drone 3 has moved closer to the reporter so as to be in a distance within which the reporter can recognize the drone 3 with eyes, the drone 3 may follow the smartphone 1 up in the air above the smartphone 1 (may fly slowly within a horizontal distance of approximately several meters from the smartphone 1 while maintaining an altitude of several meters). Accordingly, even in a case where the reporter is not used to operating the drone 3 with use of the smartphone 1, the reporter himself/herself can bring the smartphone 1 to a place where a safe landing of the drone 3 is possible, so that the drone 3 can be guided to the place where the safe landing of the drone is possible. After the drone 3 is guided to the place where the safe landing of the drone 3 is possible, an instruction to make a landing is given with use of software for operating the drone 3. This allows the drone 3 to land on a safe place.

Further, the terminal control section 15 of the smartphone 1 may transmit to the drone 3, at an appropriate interval, a position (GPS information) of the smartphone 1 measured by the positioning section 18. This allows the drone 3 to search for the smartphone 1 by referring to the GPS information of the smartphone 1 in addition to using the methods described above.

Note that FIG. 3 and descriptions related to FIG. 3 have dealt with an example case in which, as described in S206, the smartphone 1 keeps transmitting, to the drone 3, radio waves for urging the drone 3 to make a direct connection, and the drone 3 searches for the radio waves. Note, however, that it is also possible to employ a configuration in which, after the drone 3 arrives at the vicinity of the destination (YES at S202), the drone 3 transmits, to the smartphone 1, radio waves for urging the smartphone 1 to make a connection, and the smartphone 1 searches for the radio waves and makes a direct connection to the drone 3 in a case where the radio waves are found.

Further, in a case where an operation indicative of an instruction to drop goods instead of a landing instruction is inputted at S226 through S228, the smartphone 1 may transmit the instruction to drop the goods to the drone 3. Then, upon reception of the instruction to drop the goods, the drone 3 may drop the goods attached to a parachute or the like instead of making a landing as shown in S232. Alternatively, it is possible to employ a configuration in which the smartphone 1 can select between giving a landing instruction to the drone 3 and giving an instruction to drop goods to the drone 3.

Further, after landing at S232, the drone 3 may fly autonomously so as to return to a place where the drone 3 was provided (the place at which the drone 3 took off at S144 in FIG. 2), in accordance with a predetermined operation given by the reporter to the smartphone 1 or to the drone 3. Further, in a case where the drone 3 has dropped goods with use of a parachute instead of making a landing at S232, the drone 3 may return, without being instructed by the reporter, to the place where the drone 3 was provided.

Further, also in a case where the drone 3 has been unable to make a direct connection to the smartphone 1 for a predetermined time period or longer after starting to search for the smartphone 1, the drone 3 may automatically return to the place where the drone 3 was originally provided. This allows preventing, for example, an undesirable case in which the reporter calls out the drone 3 for a joke (the reporter has no intention of waiting at the vicinity of the destination) and the drone 3 keeps searching for the smartphone 1 until running out of battery (or fuel) and crashing into the ground. Note that the predetermined time period is preferably set, at a point in time when the drone 3 starts flying, to be a time period that is longer, by approximately several minutes, than a time period that is expected to be required by means other than the drone 3 (e.g., an ambulance) to deliver emergency goods.

According to the processes described above with reference to FIGS. 2 and 3, the flight control system 100 has an advantage that, irrespective of whether the drone 3 is within or outside a network, the drone 3 can reliably perform a motion intended by a user (in a case of the examples shown in FIGS. 2 and 3, the intended motion of the drone 3 is to reliably transport goods to a position desired by a reporter and land on the location).

There can be many similar cases that require the drone 3 to fly to an outside of an area of a mobile communication network such as a cellular network. One example is a case in which goods necessary in an emergency situation, such as an AED (automatic external defibrillator), are delivered to a place such as a mountain area which takes an ambulance a long time to arrive at the place. In a case where the drone 3 flies in a place such as a mountain area which is unlikely to be provided with a communication network, it is highly likely, along a route of flight, at a place to land on, in the vicinity of the place to land on, and the like, that the drone 3 has to fly or make a landing outside an area of radio waves of a cellular network to which the drone 3 connects. Further, in order to cause the drone to fly, a flight instruction needs to be given to the drone by a person in accordance with a certain method. For example, in an emergency case, it is likely that a person makes a report, to a preset party to be reported to and in accordance with a preset method with use of a mobile terminal or the like, so that the drone is called out to a place to which the person wants goods to be delivered. In such a case, when calling out a drone, the reporter first moves, for example, to a place that is inside an area of communication of radio waves of the mobile terminal owned by the person or to a place that is provided with a wired communication device, and then the reporter makes a report (calls out of the drone). At this time, the drone can identify a location of the reporter by communicating with the mobile terminal of the reporter or the wired communication device. However, in a case where the reporter returns to a place where goods are needed (a place where a sick or wounded person is present), the place may be outside the area of communication of radio waves of the mobile terminal, so that the drone cannot make a communication with use of a cellular network.

In highly emergent situations, reliable delivery of goods to a reporter is required irrespective of a situation of surroundings of the reporter, i.e., a situation of an environment of a place on which the drone lands. Accordingly, the drone needs to perform autonomous flight to a place where the reporter can reliably find the drone with eyes. Further, it is preferable that the drone be directly operated by the reporter when landing. Further, the reporter in the above-described emergency situations may not necessarily be used to operating a drone. Accordingly, an operation to be performed by the reporter (at least an operation for instructing the drone to land) needs to be as simple as possible.

According to the flight control system 100 in accordance with Embodiment 1, the drone 3 can reliably land on a place intended by the reporter, provided that the reporter successfully calls out the drone 3 first. Accordingly, goods can be reliably delivered to the reporter irrespective of a situation in an environment around the place in which the reporter is waiting. This is particularly useful in transportation of goods in an emergency. Further, since a landing instruction is given through an operation carried out by the reporter via the smartphone 1, the operation is simple, and the reporter can give the landing instruction easily even if the reporter is not used to controlling the drone 3.

### Embodiment 21

The flight control system 100 in accordance with the present invention may be configured such that, in a case where a direct connection between the smartphone 1 and the drone 3 is established and then the communication is lost, the smartphone 1 and the drone 3 can make a direct connection to each other again. The following description will discuss Embodiment 2 of the present invention. For convenience, the same reference signs are given to members having functions identical to those of members described in Embodiment 1, and descriptions of such members are therefore omitted.

A drone 3 and a smartphone 1 in accordance with Embodiment 2 are different from the drone 3 and the smartphone 1 in accordance with Embodiment 1 in that, in a case where a direct connection between the drone 3 and the smartphone 1 is established and then the communication is lost, the drone 3 and the smartphone 1 can make a direct connection to each other again. Note that, as used herein, “communication is lost” means a case in which a connection is cut off in accordance with a procedure that is not a normal procedure (a communication is ended incorrectly).

In a case where a direct connection to the smartphone 1 is established at a terminal first communication section 13 and then the communication is lost, a control section 35 of the drone 3 in accordance with Embodiment 2 instructs a movement control section 32 to control a driving section 31 without being instructed by the smartphone 1 (i.e., to cause the drone 3 to perform autonomous flight). The movement control section 32 controls the driving section 31 so that the drone 3 performs autonomous flight. Note that the “autonomous flight” in this case is not limited to the flight to a destination shown in S200 of FIG. 3. Specifically, the autonomous flight can mean that (i) the drone 3 stays in the same position in the air or (ii) the drone 3 flies along a predetermined route within a predetermined range from a current position (i.e., in order to search for the smartphone 1, the drone 3 flies around a place at which the communication was lost).

Meanwhile, in a case where the communication with the drone 3 is thus lost, the smartphone 1 in accordance with Embodiment 2 keeps transmitting radio waves for making a reconnection, until the smartphone 1 can establish a direct connection to the drone 3 again (a process similar to S206 in FIG. 3). Instead of or in addition to the transmission of the radio waves from the smartphone 1, the drone 3 may keep transmitting radio waves for requesting a direct connection.

Thus, in the flight control system 100 in accordance with Embodiment 2, in a case where a direct connection is lost, at least one of the drone 3 and the smartphone 1 keeps transmitting radio waves for making a reconnection. Then, in a case where one of the smartphone 1 and the drone 3 successfully receives radio waves from the other, the processes of S210 and S212 in FIG. 3 are carried out again so as to establish a direct connection again.

Note that it is preferable that the drone 3 start the above-described autonomous flight (and the transmission of radio waves for making a reconnection) in a case where an intensity of radio waves from the smartphone 1 in a direct connection has decreased to a predetermined value or below (i.e., in a case where the communication becomes almost lost). Further, it is preferable that the smartphone 1 also start the transmission of radio waves for making a reconnection, in a case where an intensity of radio waves from the drone 3 in a direct connection has decreased to a predetermined value or below. Further, in a case where an intensity of radio waves in a direct connection has decreased to a predetermined value or below, the smartphone 1 and the drone 3 may increase intensities of radio waves in the communication so as to maintain the direct connection.

There may be a case in which, after the drone 3 captures radio waves from the smartphone 1 and starts communicating with the smartphone 1, the communication between the drone 3 and the smartphone 1 becomes lost. In particular, in a case where the reporter operates the drone 3 with use of the smartphone 1 (e.g., in a case where the reporter radio-controls the drone 3 with use of predetermined application software on the smartphone 1), the reporter may make a mistake in operation or visual observation of the drone 3 and accidentally guide the drone 3 to a place that is so far away that a direct connection between the drone 3 and the smartphone 1 cannot be maintained.

According to the smartphone 1 and the drone 3 in accordance with Embodiment 2, even in the above-described case in which the drone 3 has become so far away from the smartphone 1 that the direct connection between the smartphone 1 and the drone 3 cannot be maintained, the smartphone 1 and the drone 3 can be reconnected to each other by moving closer to each other so as to enter a range within which radio waves transmitted from one of the smartphone 1 and the drone 3 can be captured by the other. This brings about an advantageous effect that even in a case where radio waves from the smartphone 1 does not reach the drone 3 anymore, the drone 3 can reconnect to the smartphone 1 so as to land reliably on a position desired by the reporter.

### Embodiment 3

Control blocks of each of the smartphone 1, the management server 2, and the drone 3 (particularly, the terminal control section 15, the server control section 21, the movement control section 32, and the control section 35) may be realized by a logic circuit (hardware) provided in an integrated circuit (IC chip) or the like or may be realized by software as executed by a CPU (Central Processing Unit).

In the latter case, each of the smartphone 1, the management server 2, and the drone 3 includes: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a disk, a card, a semiconductor memory, and a programmable logic circuit. Further, the program may be made available to the computer via any transmission medium (such as a communication network and a broadcast wave) which enables transmission of the program. Note that the present invention can also be implemented by the program in the form of a computer data signal embedded in a carrier wave which is embodied by electronic transmission.

### Modified Example

Note that in each of Embodiments 1 through 3, a method for transmitting “information necessary for making a direct connection” and “a current position of the smartphone 1” to the management server 2 is not limited to the method shown in FIG. 2. For example, the reporter may access, via the smartphone 1, a homepage provided by the management server 2, and input “information necessary for making a direct connection” and “a current position of the smartphone 1” via the input section 12 so as to transmit “the information necessary for making a direct connection” and “the current position of the smartphone 1” to the management server 2.

It is also possible to employ a configuration in which the reporter makes a report by calling an emergency number 119 from the smartphone 1, and a staff member or the like at a fire station who has received the report (i) obtains, by listening to the reporter or by automatic acquisition through data communication with the smartphone 1, information (information necessary for making a direct connection and a current position of the smartphone 1) of the smartphone 1 from which the report is being made and (ii) input the information to the server. In other words, the staff member may transmit the information of the smartphone 1 to the management server 2 in place of the reporter. Further, in a case where the reporter makes a report from a land line or a public phone, the reporter may verbally communicate, to the staff member, information of the smartphone 1 which is being carried by the reporter, and the staff member may input the information of the smartphone 1 to the management server 2 in accordance with the verbal communication. In such a case in which the drone 3 is called out without a direct communication made by the smartphone 1 with the management server 2, the smartphone 1 does not have to include the terminal second communication section 14.

Further, in this case, in a case where the process at S140 in FIG. 2 has ended, that is, in a case where receipt of the report has been completed, the staff member or the like at the fire station can explain to the reporter, by telephone or the like, about information indicative of things to be preferably done or understood by the owner of the smartphone 1 (i.e., the reporter) before arrival of the drone 3.

Further, although FIGS. 2 and 3 have shown an example case in which the smartphone 1 (the smartphone 1 of the reporter) which has called out the drone 3 directly connects to the drone 3, a smartphone that is used in making a report (a reporting terminal) and a smartphone that directly connects to the drone 3 (a connected terminal) may be different from each other in the flight control system 100 in accordance with the present invention.

For example, in a case where the reporting terminal does not have a function of controlling the drone 3 (specifically, for example, in a case where the reporting terminal is a terminal such as a feature phone, a land line, a public phone, or the like in which an application for controlling the drone 3 cannot be installed), terminal-identifying information (an ID and the like) and a current position of a connected terminal may be transmitted from the reporting terminal to the management server 2. Then, on the basis of the terminal-identifying information and the current position of the connected terminal which have been obtained from the management server 2, the drone 3 may set the current position as a destination, and directly connect, when arriving at the vicinity of the destination, to the connected terminal indicated by the terminal-identifying information.

Further, in a case where the reporter owns a plurality of communication terminals, among which another communication terminal (a connected terminal) is more suitable for control of the drone 3 than a communication terminal (a reporting terminal) that has been used for making a report, the reporting terminal may transmit terminal-identifying information (an ID and the like) and a current position of the connected terminal to the management server 2, and the drone 3 may directly connect to the connected terminal on the basis of the terminal-identifying information and the current position of the connected terminal which have been obtained from the management server 2.

Alternatively, the reporting terminal may transmit, to the management server 2, terminal-identifying information and a current position of a smartphone (a terminal to be used as a connected terminal) of a sick person who got suddenly sick or a person near the sick person, and the drone 3 may directly connect to the connected terminal on the basis of the terminal-identifying information and the current position of the connected terminal which have been obtained from the management server 2.

Further, the antenna (the antenna of the terminal first communication section 13) included in the drone 3 in order to make a direct connection to the smartphone 1 may be constituted by a plurality of antennas. It is particularly preferable that the antenna include (i) a first antenna which, after connecting to the smartphone 1 (after S212 in FIG. 3), transmits an image to the smartphone 1 and receives, from the smartphone 1, an instruction for being remotely operated and (ii) a second antenna for checking a direction from which radio waves from the smartphone 1 are transmitted (S204 in FIG. 3). It is preferable that the first antenna for transmitting an image to the smartphone 1 or being remotely operated by the smartphone 1 after the drone 3 has moved closer to the reporter be an antenna which has as low directivity as possible, in order to be able to make stable communications irrespective of an orientation of the drone. Meanwhile, the second antenna checks a direction in which radio waves from the smartphone 1 are transmitted, in order to move closer to the smartphone 1. Accordingly, it is preferable that the second antenna be an antenna having high directivity.

Note that a situation in which the flight control system 100 described in each of Embodiments 1 through 3 is used is not limited to the above-described emergency transportation. For example, the flight control system 100 may be used in normal transportation of goods. Alternatively, in a case where an unmanned aircraft that is used for measurement, cropdusting, or the like or an aircraft that is radio-controlled by an operator has flown (or will flow) out of an area of communication with a controller, the flight control system 100 may be used as a method for calling the unmanned aircraft back into the area of communication.

In each of Embodiments 1 through 3, the drone 3, which is a multicopter-type unmanned aircraft, has been discussed as an example of a mobile body in accordance with the present invention. However, a type, a shape, and a moving method of the mobile body in accordance with the present invention are not particularly limited, provided that the mobile body is able to move autonomously to the vicinity of a destination which has been set. For example, it is possible to employ, as the mobile body in accordance with the present invention, (i) an unmanned aircraft (such as a fixed-wing aircraft or an airship) which autonomously flies in accordance with other flight methods (ii) a car or a walking robot which autonomously moves on land, or (iii) a ship which autonomously moves on water. It is preferable that an optimum movement method be employed, as a type, a shape, and a movement method of the mobile body in accordance with the present invention, depending on environments of a destination, a route to the destination, and a place at which the mobile body is to stop (a place at which landing is performed in each of Embodiments 1 through 3).

In a case where at least one of these various movement methods is employed, the mobile body in accordance with the present invention includes a driving section 31 that is suitable for the movement method(s) employed by the mobile body. For example, the mobile body includes, as the driving section 31, (i) a wheel or an ambulation device in a case of moving on land, and (ii) a screw propeller or the like in a case of moving on water.

Note that the mobile body in accordance with the present invention may employ a plurality of movement methods. For example, the drone 3 may be capable of autonomously moving on land or water, as well as autonomously flying. In a case of a mobile body which is thus capable of moving in accordance with a plurality of movement methods, the mobile body may include, as the driving section 31, a plurality of types of driving sections 31 such as, for example, a driving section 31 for flying and a driving section 31 for running on land. Further, it is only necessary that the drone 3 include a movement control section 32 that is capable of making appropriate controls of the respective plurality of types of driving sections 31.

Further, the mobile body in accordance with the present invention may make a combined use of a plurality of movement methods in order to move to a destination or to a place at which the mobile body is to stop. Note that, in a case where the mobile body is capable of flying, flying can be employed as a movement method with a higher priority than other movement methods. In general, the movement method “flying” is less restricted by geographical features than movement on land or on water. Accordingly, the movement method “flying” enables high speed movement. The movement method “flying” also has an advantage that the reporter can find the mobile body more easily, since the mobile body is less likely to blend in a background scene when flying, as compared with a case in which the mobile body moves on land or on water. As such, in a case where the mobile body is capable of fling and it is not appropriate to move to a destination by flying all the way (e.g., in a case where the destination is in a no-fly zone), the mobile body may fly up to a point before the destination (e.g., immediately before the no-fly zone) and then make a landing on land or on water and move to the destination by running on a road or on a water surface.

[Recap]

A mobile body (a drone 3) in accordance with Aspect 1 of the present invention is a mobile body performing autonomous movement to the vicinity of a destination which has been set, including: a first communication section (a first communication section 33) wirelessly connecting to a communication terminal (a smartphone 1) which controls the mobile body in accordance with an input operation; a terminal position identification section (a control section 35) identifying a position of the communication terminal which has been wirelessly connected to by the first communication section; and a movement control section (a movement control section 32) controlling the autonomous movement so that the mobile body moves closer to the position identified by the terminal position identification section.

According to the configuration above, the first communication section of the mobile body which performs autonomous movement to the vicinity of the destination wirelessly connects to the communication terminal which controls the mobile body. Note that, as used herein, “wirelessly connects” means that the mobile body and the communication terminal directly connect to each other without being mediated by another device (e.g., a network device which relays control information from the communication terminal to the mobile body) which relays a communication. Then, the terminal position identification section identifies a position of the communication terminal which has been wirelessly connected to, and the movement control section controls the autonomous movement of the mobile body so that the mobile body moves closer to the position.

In this manner, the mobile body gradually moves closer to the communication terminal to which the mobile body has connected. This allows an owner of the communication terminal to see the mobile body more easily. The owner of the communication terminal is then able to control the mobile body, which is visible to the owner, via the communication terminal. Thus, the mobile body can directly connect to the communication terminal and be controlled by the owner of the communication terminal, irrespective of being within or outside an area of a network. This allows the mobile body to reliably perform a motion intended by the owner of the communication terminal.

In Aspect 2 of the present invention, the mobile body in accordance with Aspect 1 may be configured such that the mobile body further includes a second communication section (a second communication section 34) receiving, from a management device (a management server 2) which has received a calling request from the communication terminal to call out the mobile body, terminal-identifying information for identifying the communication terminal which has made the calling request, the first communication section wirelessly connecting, in the vicinity of the destination, to the communication terminal indicated by the terminal-identifying information.

According to the configuration above, the mobile body wirelessly connects to the communication terminal, which has called out the mobile body, in the vicinity of the destination on the basis of the terminal-identifying information received from the management device. Accordingly, the mobile body can wirelessly connect to the communication terminal which has called out the mobile body, i.e., the communication terminal owned by the person who has called out the mobile body.

In Aspect 3 of the present invention, the mobile body in accordance with Aspect 2 may be configured such that: the second communication section receives, from the management device and as information indicative of the destination, a position, at the time of the calling request, of the communication terminal which has made the calling request; and the first communication section wirelessly connects to the communication terminal in the vicinity of the destination indicated by the information indicative of the destination.

According to the configuration above, the mobile body sets, as the destination, a position, at the time of the calling request, of the communication terminal which has made the calling request. Accordingly, the mobile body can head to a place where the communication terminal which has called out the mobile body, i.e., the person who has called out the mobile body, is present.

In Aspect 4 of the present invention, the mobile body in accordance with any one of Aspects 1 through 3 may be configured such that: the mobile body is a radio-controlled aircraft which performs autonomous flight; the first communication section receives a landing instruction from the communication terminal which has been wirelessly connected to by the first communication section; and the movement control section causes the mobile body to land in accordance with the landing instruction.

According to the configuration above, the movement control section causes the mobile body to land in accordance with the landing instruction from the communication terminal. Accordingly, the mobile body (the radio-controlled aircraft) can reliably land on a position intended by the owner of the communication terminal.

A communication terminal (smartphone 1) in accordance with Aspect 5 of the present invention is a communication terminal including: a calling section (a calling section 151) transmitting a calling request for causing a mobile body (a drone 3), which performs autonomous movement to a destination which has been set, to move to the vicinity of the communication terminal; a wireless connection section (a terminal first communication section 13) wirelessly connecting to the mobile body which has performed autonomous movement to the vicinity of the destination; and an instruction transmission section (a drone operation section 152) transmitting an instruction for controlling the autonomous movement of the mobile body so that the mobile body, which has been wirelessly connected to, moves closer to the communication terminal. According to the configuration above, the communication terminal brings about an advantageous effect similar to that of the mobile body described above.

In Aspect 6 of the present invention, the communication terminal in accordance with Aspect 5 may be configured such that: the mobile body is a radio-controlled aircraft which performs autonomous flight; and the instruction transmission section transmits a landing instruction for causing the radio-controlled aircraft to land. According to the configuration above, the communication terminal brings about an advantageous effect similar to that of the mobile body described above.

A method for controlling a mobile body (a drone 3) in accordance with Aspect 7 of the present invention is a method for controlling a mobile body performing autonomous movement to the vicinity of a destination which has been set, the method including: a first communication step (S210) of wirelessly connecting to a communication terminal (a smartphone 1) which controls the mobile body in accordance with an input operation; a terminal position identification step (S214) of identifying a position of the communication terminal which has been wirelessly connected to through the first communication step; and a movement control step (S215) of controlling the autonomous movement of the mobile body so that the mobile body moves closer to the position identified through the terminal position identification step.

In Aspect 8 of the present invention, the method for controlling a mobile body in accordance with Aspect 7 may be configured such that: the mobile body is a radio-controlled aircraft which performs autonomous flight; the first communication step includes receiving a landing instruction from the communication terminal which has been wirelessly connected to; and the movement control step includes causing the mobile body to land in accordance with the landing instruction.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

100: flight control system
1: smartphone (communication terminal)
13: terminal first communication section (wireless connection section)
14: terminal second communication section
15: terminal control section
151: calling section
152: drone operation section (instruction transmission section)
2: management server (management device):
3: drone (mobile body)
32: movement control section
33: first communication section
34: second communication section
35: control section (terminal position identification section)

1. A mobile body performing autonomous movement to the vicinity of a destination which has been set, comprising:
a first communication section wirelessly connecting to a communication terminal which controls the mobile body in accordance with an input operation;
a terminal position identification section identifying a position of the communication terminal which has been wirelessly connected to by the first communication section; and
a movement control section controlling the autonomous movement so that the mobile body moves closer to the position identified by the terminal position identification section.

2. The mobile body as set forth in claim 1, further comprising a second communication section receiving, from a management device which has received a calling request from the communication terminal to call out the mobile body, terminal-identifying information for identifying the communication terminal which has made the calling request,
the first communication section wirelessly connecting, in the vicinity of the destination, to the communication terminal indicated by the terminal-identifying information.

3. The mobile body as set forth in claim 2, wherein:
the second communication section receives, from the management device and as information indicative of the destination, a position, at the time of the calling request, of the communication terminal which has made the calling request; and
the first communication section wirelessly connects to the communication terminal in the vicinity of the destination indicated by the information indicative of the destination.

4. A communication terminal comprising:
a calling section transmitting a calling request for causing a mobile body, which performs autonomous movement to a destination which has been set, to move to the vicinity of the communication terminal;
a wireless connection section wirelessly connecting to the mobile body which has performed autonomous movement to the vicinity of the destination; and
an instruction transmission section transmitting an instruction for controlling the autonomous movement of the mobile body so that the mobile body, which has been wirelessly connected to, moves closer to the communication terminal.

5. A method for controlling a mobile body performing autonomous movement to the vicinity of a destination which has been set,
the method comprising:
a first communication step of wirelessly connecting to a communication terminal which controls the mobile body in accordance with an input operation;
a terminal position identification step of identifying a position of the communication terminal which has been wirelessly connected to through the first communication step; and
a movement control step of controlling the autonomous movement of the mobile body so that the mobile body moves closer to the position identified through the terminal position identification step.
